(19) United States
(12) Patent Application Publication
(10) Pub. No.: US 2026/0098145 A1
(43) Pub. Date: Apr. 9, 2026

(54) RUBBER COMPOSITION AND RUBBER

(71) Applicants: TOAGOSEI CO., LTD., Tokyo (JP); SHINSHU UNIVERSITY, Nagano (JP)

(72) Inventors: Akihiro GOTOU, Kanagawa (JP); Jun TAKADA, Kanagawa (JP); Yuugo MIYATA, Aichi (JP); Toru NOGUCHI, Nagano (JP); Isao ODAKA, Nagano (JP); Yasuo BAMBA, Nagano (JP)

(73) Assignees: TOAGOSEI CO., LTD., Tokyo (JP); SHINSHU UNIVERSITY, Nagano (JP)

(21) Appl. No.: 19/137,395

(22) PCT Filed: Dec. 6, 2023
(86) PCT No.: PCT/JP2023/043623

§ 371 Date: Jun. 10, 2025

(30) Foreign Application Priority Data
Dec. 26, 2022 (JP) 2022-208459

(51) Int. Cl. C08L 9/04

(52) U.S. Cl. CPC C08L 9/04; C08L 2310/00; C08L 2312/00

(57) ABSTRACT

A rubber composition containing a nanocellulose and a rubber component, in which
the nanocellulose contains a cellulose raw-material oxidized with a hypochlorous acid or a salt thereof and substantially contains no N-oxyl compound, and
a ratio of a breaking-elongation value of a rubber formed from the rubber composition relative to a breaking-elongation value of a control rubber formed from a control rubber composition, which is prepared by removing the nanocellulose from the rubber composition, is 0.90 or more and less than 1.15.

### TECHNICAL FIELD

The present invention relates to a rubber composition and a rubber.

### BACKGROUND ART

In recent years, as a material light in weight and excellent in strength, rubber reinforced in strength by blending a reinforcing material has been widely used. Studies for using a plant fiber as a reinforcing material for a resin have been conducted. The plant fiber is not artificially synthesized but a plant-derived fiber is fibrillated and put in use. When a plant fiber is combusted, almost no ash remains. Thus, problems such as disposal of ash in an incinerator and landfill do not occur. For this reason, studies on a plant fiber used as a reinforcing material for a resin have been conducted. In particular, studies have been conducted on use of a nanocellulose, which is obtained by fibrillating a plant fiber up to a nano level.

As a type of nanocellulose, a nanocellulose derived from an oxide is known, which is obtained by oxidizing a cellulose raw-material with hypochlorous acid or a salt thereof. For example, Patent Literature 1 discloses a method for producing a nanocellulose having a step of oxidizing a cellulose raw-material with hypochlorous acid or a salt thereof having an available chlorine concentration of 14 to 43 mass % to produce oxidized cellulose and a step of fibrillating the oxidized cellulose into a nanocellulose. Patent Literature 2 discloses a method for producing a nanocellulose having a step of subjecting a cellulose raw-material to an oxidation reaction using hypochlorous acid or a salt thereof having an available chlorine concentration of 6 mass % to 14 mass % while controlling pH to fall within the range of 5.0 to 14.0, and fibrillating the oxidized cellulose into nanofiber.

A cellulosic fiber is sometimes used as a reinforcing material in order to enhance the strength of rubber. However, when the cellulosic fiber is used as a reinforcing material for rubber, if a hydrophilic cellulose and hydrophobic rubber is used in combination, the affinity and dispersibility of the reinforcing material in rubber is poor. In this case, rubber properties cannot be sufficiently exhibited.

Patent Literature 3 is directed to providing a rubber composition for tires having improved mechanical properties higher than a conventional level. More specifically, Patent Literature 3 discloses “a rubber composition for tires characterized by blending 1 to 50 parts by mass of an oxidized cellulose nanofiber with 100 parts by mass of diene rubber containing 5 mass % or more of modified diene rubber having 0.1 mol % or more of a polar group.”

Patent Literature 4 is directed to providing a composite material having a rubber component reinforced with a cellulose nanofiber, more specifically discloses “a composite material comprising a rubber component, a cationic surfactant, a cellulose nanofiber, and a silicon atom-containing hydrophobizing agent, wherein the silicon atom-containing hydrophobizing agent is at least one selected from a silane compound represented by the following formula (1) and having two or more hydroxyl groups or alkoxy groups in one molecule and/or an organosilazane compound made of partially hydrolyzed condensate thereof, and an organosilazane compound, and the cellulose nanofiber is blended in an amount of 5.0 parts by mass to 40.0 parts by mass based on 100 parts by mass of the rubber component, the cationic surfactant is blended in an amount of 0.1 parts by mass to 2.5 parts by mass relative to 1 part by mass of the cellulose nanofiber, and the silicon atom-containing hydrophobizing agent is blended in an amount of 0.05 parts by mass or more relative to 1 part by mass of the cellulose nanofiber and in an amount of 30.0 parts by mass or less relative to 100 parts by mass of the rubber component. R²ₘSi(OR¹)₄₋ₘ (1)
wherein, R¹ is hydrogen atom or a hydrocarbon group having 1 to 4 carbon atoms, R² is an unsubstituted or substituted hydrocarbon group having 1 to 10 carbon atoms, and m is 0, 1 or 2.”

In Patent Literatures 3 and 4, as an oxidized cellulose nanofiber or a cellulose nanofiber, more specifically, a nanofiber obtained by oxidation with 2,2,6,6-tetramethylpiperidine-1-oxyl (TEMPO) is used.

### CITATION LIST

### Patent Literature

Patent Literature 1: WO 2018/230354 A
Patent Literature 2: WO 2020/027307 A
Patent Literature 3: JP 2019-147877 A
Patent Literature 4: JP 2021-014512 A

### SUMMARY OF INVENTION

### Technical Problem

An object of the invention is to provide a rubber composition from which a rubber having excellent tensile strength while maintaining breaking elongation can be formed.

### Solution to Problem

The present inventors conducted intensive studies. As a result, they found that a rubber having excellent tensile strength while maintaining breaking elongation can be formed by using a nanocellulose obtained by fibrillation of a cellulose raw-material oxidized with a hypochlorous acid or a salt thereof.

The invention includes the following embodiments.

[1]

A rubber composition containing a nanocellulose and a rubber component, in which
the nanocellulose contains a cellulose raw-material oxidized with a hypochlorous acid or a salt thereof and substantially contains no N-oxyl compound, and
a ratio of a breaking-elongation value of a rubber formed from the rubber composition relative to a breaking-elongation value of a control rubber formed from a control rubber composition, which is prepared by removing the nanocellulose from the rubber composition, is 0.90 or more and less than 1.15.
   [1-1]

The rubber composition according to [1], in which the ratio of the breaking-elongation value of the rubber relative to the breaking-elongation value of the control rubber is 0.90 or more and less than 1.15.

[1-2]

The rubber composition according to [1] or [1-1], in which the ratio of the breaking-elongation value of the rubber relative to the breaking-elongation value of the control rubber is 0.95 or more and 1.10 or less.

[1-3]

The rubber composition according to any one of [1] to [1-2], in which the ratio of the breaking-elongation value of the rubber relative to the breaking-elongation value of the control rubber is 1.00 or more and 1.05 or less.

[2]

The rubber composition according to any one of [1] to [1-3], in which the content of the nanocellulose is 0.5 parts by mass or more and 50 parts by mass or less based on 100 parts by mass of the rubber component.

[3]

The rubber composition according to [1] or [2], in which the rubber composition is used as a masterbatch.

[4]

A rubber formed from the rubber composition according to any one of [1] to [3].

[5]

A rubber formed from a rubber composition, in which
the rubber composition contains a nanocellulose and a rubber component,
the nanocellulose contains a cellulose raw-material oxidized with a hypochlorous acid or a salt thereof and substantially contains no N-oxyl compound, and
a ratio of a breaking-elongation value of the rubber relative to a breaking-elongation value of a control rubber formed from a control rubber composition, which is prepared by removing the nanocellulose from the rubber composition, is 0.90 or more and less than 1.15.
   [5-1]

The rubber according to [5], in which the ratio of the breaking-elongation value of the rubber relative to the breaking-elongation value of the control rubber is 0.90 or more and less than 1.15.

[5-2]

The rubber according to [5] or [5-1], wherein the ratio of the breaking-elongation value of the rubber relative to the breaking-elongation value of the control rubber is 0.95 or more and 1.10 or less.

[5-3]

The rubber according to any one of [5] to [5-2], in which the ratio of the breaking-elongation value of the rubber relative to the breaking-elongation value of the control rubber is 1.00 or more and 1.05 or less.

### Advantageous Effects of Invention

According to the invention, it is possible to provide a rubber composition from which a rubber having excellent tensile strength while maintaining breaking elongation can be formed.

### BRIEF DESCRIPTION OF DRAWINGS

FIG. 1 shows stress-strain curves of a case where only nitrile butadiene rubber (NBR) was used and a case where a nanocellulose oxidized with hypochlorous acid and NBR were used.

### DESCRIPTION OF EMBODIMENTS

Hereinafter, embodiments of the invention will be more specifically described, but the invention is not limited thereto, and can be modified in various ways without departing from the gist thereof.

### <Rubber Composition>

An embodiment of the invention relates to a rubber composition containing a nanocellulose and a rubber component, in which the nanocellulose contains a cellulose raw-material oxidized with a hypochlorous acid or a salt thereof, and substantially contains no N-oxyl compound; and the ratio of the breaking-elongation value of a rubber formed from the rubber composition relative to the breaking-elongation value of a control rubber formed from a control rubber composition, which is prepared by removing the nanocellulose from the rubber composition, is 0.90 or more and less than 1.15.

The rubber composition according to the present embodiment can form a rubber having excellent tensile strength while maintaining breaking elongation. When a nanocellulose oxidized with TEMPO is used, the tensile strength improves but the breaking elongation decreases, whereas when a nanocellulose oxidized with hypochlorous acid or a salt thereof is used, the tensile strength improves while maintaining the breaking elongation. This is a surprising finding. The reason why the breaking elongation is maintained is presumably because, for example, a rubber component interacts with a carboxy group of a nanocellulose oxidized with hypochlorous acid or a salt thereof, but the invention is not limited by the presumption.

The ratio of the breaking-elongation value of the rubber formed from the rubber composition relative to the breaking-elongation value of the control rubber formed from the control rubber composition (hereinafter, referred to as a “breaking-elongation ratio”) is preferably 0.90 or more, more preferably 0.95 or more, and still more preferably 1.00 or more. The upper limit of the breaking-elongation ratio is not particularly limited, but may be, for example, less than 1.15, 1.10 or less, or 1.05 or less. The range of the breaking-elongation ratio can be determined based on the upper limits and lower limits appropriately in combination. The range of the breaking-elongation ratio may be, for example, 0.90 or more and less than 1.15, 0.95 or more and 1.10 or less, or 1.00 or more and 1.05 or less.

The breaking-elongation ratio can be controlled by, varying, for example, the content of a nanocellulose, the type of rubber component, or a method of mixing a nanocellulose and a rubber component. For example, the breaking-elongation ratio tends to be increased by increasing the content of a nanocellulose.

The method for measuring the breaking elongation of the rubber formed from the rubber composition according to the embodiment and the control rubber formed from the control rubber composition is as follows.

(1) No. 6 dumbbell-form measurement samples specified in JIS K6251 (thickness: 1.1 to 1.2 mm) are cut out from the sheet-like rubber or control rubber.

(2) The measurement samples are subjected to a tensile test based on JIS K6251 by a tensile tester (e.g., INSTRON 5566A manufactured by Instron) at 23±2° C., a gauge length of 20 mm, and a tension rate of 500 mm/min.

The method for forming the rubber and the control rubber is as follows.

(1) A rubber composition or a control rubber composition is pre-kneaded for 5 minutes by a melt kneader (for example, Labo Plastomill 10S100, mixer R60, and Banbury blade manufactured by Toyo Seiki Seisaku-sho, Ltd.) at a set temperature of 40° C. and a rotation number of 60 rpm.

(2) To the kneaded product, 3.2 phr of a crosslinking agent (for example, PERCUMYL D manufactured by NOF CORPORATION) is added. The mixture is further kneaded for 10 minutes.

(3) The kneaded product containing the crosslinking agent is placed in a mold of 1 mm in thickness, the upper and lower portions of the mold are sandwiched by SUS plates. Processing is performed by a hot-press machine at 165° C. and 20 MPa for 30 minutes to obtain a sheet-like rubber.

The method for measuring breaking elongation and the method for forming rubber and control rubber will be more specifically described in Examples (later described).

The control rubber composition prepared by removing the nanocellulose from the rubber composition according to the embodiment may be prepared by mixing the same types and amounts of components as in the rubber composition except the nanocellulose.

The rubber composition according to the embodiment may be used as a masterbatch. More specifically, the rubber composition according to the embodiment may be mixed with, e.g., another rubber component, and put in use.

### [Oxidized Cellulose]

The “oxidized cellulose” in the specification means a cellulose raw-material oxidized with hypochlorous acid or a salt thereof and not fibrillated.

Examples of hypochlorous acid or a salt thereof include aqueous hypochlorous acid, sodium hypochlorite, potassium hypochlorite, calcium hypochlorite, and ammonium hypochlorite.

The use amount of hypochlorous acid or a salt thereof is not particularly limited. Hypochlorous acid or a salt thereof is preferably used so as to obtain an available chlorine concentration of 6 to 43 mass % in the reaction system. The available chlorine concentration may be as low as 6 to 14 mass % or as high as 14 to 43 mass %.

The available chlorine concentration of hypochlorous acid or a salt thereof is defined as follows. Hypochlorous acid is a weak acid present in the form of an aqueous solution, whereas the salt of hypochlorous acid is a compound obtained by substituting the hydrogen of hypochlorous acid with another cation. For example, sodium hypochlorite as a salt of hypochlorous acid exists in a solvent (preferably in an aqueous solution). Thus, the concentration of sodium hypochlorite is measured not as the concentration of sodium hypochlorite but as the available chlorine amount in a solution. With respect to the available chlorine of sodium hypochlorite herein, the oxidizing power of a divalent oxygen atom generated by decomposition of sodium hypochlorite corresponds to 2 atom-equivalents of monovalent chlorine. Thus, the bonded chlorine atom in sodium hypochlorite (NaClO) has the same oxidizing power as that of 2 atoms of non-bonded chlorine atoms (Cl₂). That is, the available chlorine=2×(chlorine in NaClO). The measurement procedure is more specifically as follows. First, a sample is weighed. To this, water, potassium iodide, and acetic acid are added and allowed to stand. The iodine liberated is titrated with a sodium thiosulfate solution using an aqueous starch solution as an indicator. In this manner, the available chlorine concentration is measured.

The cellulose raw-material is not particularly limited as long as it is a material mainly containing cellulose. Examples thereof include pulp, natural cellulose, and fine cellulose depolymerized by mechanical treatment of cellulose. The cellulose raw-material preferably has type-I crystal structure. As the cellulose raw-material, a commercially available product of e.g., crystalline cellulose using pulp as a raw material, can be directly used. Other than this, unutilized biomass rich in cellulose component, such as okara or soy hull, may be used as a raw material. For facilitating permeation of the oxidant to be used into the starting pulp, the cellulose raw-material may be previously treated with an alkali having an appropriate concentration.

Note that cellulose is a main component of plants. A bundle of cellulose molecules is referred to as a cellulose microfibril. The cellulose in the cellulose raw-material is also contained in the form of cellulose microfibril.

### (N-Oxyl Compound)

The oxidized cellulose in the embodiment is obtained by oxidizing a cellulose raw-material with hypochlorous acid or a salt thereof. In this oxidation, an N-oxyl compound such as TEMPO is not used. For this reason, the oxidized cellulose substantially contains no N-oxyl compound. Thus, the oxidized cellulose is highly safe because the influences of an N-oxyl compound on the environment and human bodies are sufficiently reduced.

In the specification, the phrase that oxidized cellulose “substantially contains no N-oxyl compound” means that an N-oxyl compound is not used in producing oxidized cellulose; an N-oxyl compound is not contained at all in oxidized cellulose; or the content of the N-oxyl compound is 2.0 mass ppm or less, and preferably 1.0 mass ppm or less, based on the total amount of oxidized cellulose.

Also, a case where the content of an N-oxyl compound increased by preferably 2.0 mass ppm or less and more preferably 1.0 mass ppm or less, compared to the cellulose raw-material is regarded as the case where oxidized cellulose “substantially contains no N-oxyl compound.”

The content of an N-oxyl compound can be determined by a means commonly known. Examples of the means commonly known include a method using a total trace-amount nitrogen analyzer (for example, apparatus name: TN-2100H manufactured by Nittoseiko Analytech Co., Ltd.).

### (Content of Carboxy Group)

The content of a carboxy group in oxidized cellulose according to the embodiment is preferably 0.20 to 2.0 mmol/g. If the content of a carboxy group is 0.20 mmol/g or more, oxidized cellulose can be sufficiently easily fibrillated. As a result, even when the fibrillation treatment is performed under mild conditions, it is possible to obtain a nanocellulose-containing slurry uniform in quality and stable in viscosity, and improve handling thereof. In contrast, if the content of a carboxy group is 2.0 mmol/g or less, it is possible to suppress excessive decomposition of cellulose during the fibrillation process, and obtain a nanocellulose uniform in quality and having a low ratio of particulate cellulose. As a result, it is considered that dispersibility is improved.

From the above viewpoint, the content of a carboxy group in the oxidized cellulose is more preferably 0.30 mmol/g, more preferably 0.35 mmol/g, more preferably 0.40 mmol/g or more, more preferably 0.42 mmol/g or more, more preferably 0.50 mmol/g or more, more preferably more than 0.50 mmol/g, and still more preferably 0.55 mmol/g or more.

The content of a carboxy group in oxidized cellulose may be less than 2.0 mmol/g, 1.5 mmol/g or less, 1.2 mmol/g or less, 1.0 mmol/g or less, or 0.9 mmol/g or less.

Preferred ranges for the content of a carboxy group can be determined based on the upper limits and lower limits appropriately in combination. The content of a carboxy group in the oxidized cellulose is more preferably 0.30 to 2.0 mmol/g, more preferably 0.35 or more to less than 2.0 mmol/g, more preferably 0.35 to 1.5 mmol/g, more preferably 0.40 to 1.5 mmol/g, more preferably 0.50 to 1.2 mmol/g, more preferably more than 0.5 to 1.2 mmol/g or less, and still more preferably 0.55 to 1.0 mmol/g.

The content (mmol/g) of a carboxy group in oxidized cellulose is a value computationally obtained as follows. To an aqueous solution having the oxidized cellulose and water mixed therein, a 0.1 M aqueous hydrochloric acid solution is added to set pH at 2.5. Thereafter, a 0.05 N aqueous sodium hydroxide solution is added dropwise and the electrical conductivity is measured until the pH reached 11.0. The amount (a) of sodium hydroxide, which is consumed in a stage of neutralizing weak acid where the electrical conductivity slightly changed, is obtained and substituted into the following formula. The details are described in Examples (described later). The content of a carboxy group can be controlled by varying, e.g., the time and temperature of the oxidation reaction, the pH of a reaction solution.

Carboxy-group content=a (ml)×0.05/oxidized cellulose mass (g)

The oxidized cellulose of the embodiment preferably has a structure where at least two of the hydroxyl groups of a glucopyranose ring constituting cellulose are oxidized, and more specifically, a structure where the hydroxyl groups at positions 2 and 3 of the glucopyranose ring are oxidized and dicarboxy groups are introduced. The hydroxyl group at position 6 of the glucopyranose ring in the oxidized cellulose is preferably not oxidized and remains as it is. Note that, the positions of the carboxy groups in the glucopyranose ring that the oxidized cellulose has can be analyzed using solid-state ¹³C-NMR spectroscopy.

Rayon has the same chemical structure as cellulose, and its oxide (rayon oxide) is soluble in water. When rayon oxide is dissolved in heavy water and solution-state one-dimensional ¹³C-NMR measurement is performed, a peak of carbon belonging to the carboxy group is observed at 165 to 185 ppm. In one embodiment of the cellulose raw-material oxidized with hypochlorous acid or a salt thereof, two signals appear in this chemical-shift range. When solution-state two-dimensional NMR measurement is further performed, it can be determined that the carboxy groups are introduced into the 2 and 3-positions.

In solid-state ¹³C-NMR of a cellulose raw-material oxidized with hypochlorous acid or a salt thereof, two signals appear at 165 to 185 ppm when a carboxy group is introduced in a large amount, whereas when a carboxy group is introduced in a small amount, a very broad signal can appear. As is apparent from the results of rayon oxide, the signals of carbons of the carboxy groups introduced at the 2- and 3-positions are close to each other and separation of the two signals is insufficient by low-resolution solid-state ¹³C-NMR. As mentioned above, when the introduction amount of the carboxy group is low, a broad signal is observed. In short, in the solid-state ¹³C-NMR spectrum, it can be confirmed that a carboxy group is introduced in the 2- and 3-positions based on evaluation of the broad peak appearing at 165 to 185 ppm.

That is, a baseline is added to the peak in the range of 165 ppm to 185 ppm in the solid-state ¹³C-NMR spectrum and the overall area value is obtained. Thereafter, the ratio of the two peak area values (larger area value/smaller area value), which is obtained by the perpendicular partitioning of the area value at the peak top, is determined. If the ratio of the peak area values is 1.2 or more, the peak can be determined as a broad peak.

The presence/absence of the broad peak can be determined based on the ratio between the length L of the baseline in the range of 165 ppm to 185 ppm and the length L′ of the perpendicular line from the peak top to the baseline. Thus, when the ratio L′/L is 0.1 or more, it can be determined that the broad peak is present. This ratio L′/L may be 0.2 or more, 0.3 or more, 0.4 or more, or 0.5 or more. While the upper limit of the ratio L′/L is not particularly limited. Generally, the upper limit is 3.0 or less and may be less than or equal to 2.0 or less than or equal to 1.0.

The structure of the glucopyranose ring can be determined also by analysis based on the method disclosed in Sustainable Chem. Eng. 2020, 8, 48, 17800-17806.

### (Degree of Polymerization)

The polymerization degree of the oxidized cellulose in the embodiment is preferably 600 or less. When the polymerization degree of the oxidized cellulose is 600 or less, energy required for fibrillation is reduced, and fibrillation tends to easily occur. Furthermore, since the amount of oxidized cellulose insufficiently fibrillated is reduced, dispersibility tends to be improved. Moreover, the size of the obtained nanocellulose becomes uniform, and the viscosity of the slurry containing a nanocellulose tends to be low.

In view of ease of fibrillation, the lower limit of the polymerization degree of the oxidized cellulose is not specified. However, when the polymerization degree of oxidized cellulose is less than 50, the ratio of particulate cellulose increases compared to fibrous cellulose, with the result that the function as a dispersant may deteriorate. From the above viewpoint, the polymerization degree of the oxidized cellulose preferably falls within the range of 50 or more to 600 or less.

The polymerization degree of the oxidized cellulose is more preferably 580 or less, more preferably 560 or less, more preferably 550 or less, more preferably 500 or less, more preferably 450 or less, and still more preferably 400 or less.

The polymerization degree of the oxidized cellulose is more preferably 60 or more, more preferably 70 or more, more preferably 80 or more, more preferably 90 or more, more preferably 100 or more, more preferably 110 or more, and still more preferably 120 or more.

A preferred range for the polymerization degree can be determined based on the upper limits and lower limits appropriately in combination. The polymerization degree of the oxidized cellulose is more preferably 60 to 600, more preferably 70 to 600, more preferably 80 to 600, more preferably 80 to 550, still more preferably 80 to 500, more preferably 80 to 450, and still more preferably 80 to 400.

The polymerization degree of the oxidized cellulose can be controlled by varying, e.g., the time and temperature during an oxidation reaction, and pH, and the available chlorine concentration of hypochlorous acid or a salt thereof. To be more specific, as the degree of oxidation increases, the polymerization degree tends to decrease. With this tendency, the polymerization degree can be decreased by a method of increasing the time and temperature during an oxidation reaction. As an alternative method, the polymerization degree of oxidized cellulose can be controlled by the stirring condition of a reaction system during an oxidation reaction. For example, as long as the reaction system is sufficiently and homogeneously stirred by e.g., a stirring blade, the oxidation reaction smoothly proceeds and a polymerization degree tends to decrease. In contrast, in conditions under which stirring of a reaction system tends to be insufficiently made, as is the case for stirring by a stirrer, a reaction does not proceed uniformly. As a result, it becomes difficult to sufficiently decrease the polymerization degree of the oxidized cellulose. Also, the polymerization degree of the oxidized cellulose tends to vary depending on the selection of a cellulose raw-material. For this reason, the polymerization degree of the oxidized cellulose can be also controlled by selecting a cellulose raw-material.

The polymerization degree of an oxidized cellulose is an average polymerization degree (viscosity-average polymerization degree) determined by the viscosity method. The polymerization degree of an oxidized cellulose can be determined by the following method.

An oxidized cellulose is added to an aqueous sodium borohydride solution controlled at pH10 and a reduction treatment is performed for 5 hours at 25° C. The amount of sodium borohydride is set to 0.1 g relative to 1 g of the oxidized cellulose. After the reduction treatment, solid-liquid separation is performed by suction filtration and washing is made with water. The obtained oxidized cellulose is lyophilized. The oxidized cellulose dried (0.04 g) is added to 10 ml of pure water. After the mixture is stirred for 2 minutes, 10 ml of a 1 M copper ethylenediamine solution is added to dissolve the cellulose. Thereafter, the flow-time of a blank solution and the flow-time of the cellulose solution are measured by a capillary viscometer at 25° C. The relative viscosity (ηr), specific viscosity (ηsp), and intrinsic viscosity ([η]) were sequentially determined based on the flow time (t0) of the blank solution, the flow time (t) of the cellulose solution, and the oxidized cellulose concentration (c [g/ml]) in accordance with the following formula. Then, the polymerization degree (DP) of the oxidized cellulose was calculated in accordance with the viscometric formula.

$$η r = η / η 0 = t / t 0$$

$$η sp = η r - 1$$

$$[ η ] = η sp / ( 100 \times c ( 1 + 0.28 η sp ) )$$

$$DP = 175 \times [ η ]$$

### [Method for Producing Oxidized Cellulose]

An oxidized cellulose according to the embodiment can be produced by oxidizing a cellulose raw-material with hypochlorous acid or a salt thereof. A production method is more specifically disclosed in WO 2022/009979 A and WO 2022/009980 A. An oxidized cellulose may be a commercially available product such as ARONFIBRO (registered trademark) manufactured by Toagosei Co., Ltd.

### [Nanocellulose]

The “nanocellulose” in the specification refers to a cellulose raw-material oxidized with hypochlorous acid or a salt thereof and fibrillated.

Nanocellulose is a collective term meaning microfibrillated cellulose materials including fine cellulose fibers and cellulose nanocrystals. The fine cellulose fibers are also called as cellulose nanofiber (CNF).

The nanocellulose contains a carboxy group. The carboxy group may have a form of —COOH or a salt. Examples of the salt include, but are not particularly limited to, alkali metal salts such as a lithium salt, a sodium salt, and a potassium salt; alkaline earth metal salts such as a calcium salt and a barium salt; other metal salts such as a magnesium salt and an aluminum salt; ammonium salts; and organic amine salts.

The nanocellulose refers to a group of fibers having nanoscale per unit. In the case where the nanocellulose contains a carboxylated nanocellulose, it is sufficient that the nanocellulose contains at least one carboxylated nanocellulose, and preferably contains the carboxylated nanocellulose as a main component. Here, the phrase “contains a carboxylated nanocellulose as a main component” means that the ratio of the carboxylated nanocellulose relative to the total amount of the nanocellulose is more than 50 mass %, preferably more than 70 mass %, and more preferably more than 80 mass %. The upper limit of the ratio is 100 mass %, but 98 mass % or 95 mass % is acceptable.

### (N-Oxyl Compound)

The nanocellulose in the embodiment substantially contains no N-oxyl compound. The meaning that the nanocellulose “substantially contains no N-oxyl compound” and the method for measuring the content of an N-oxyl compound are the same as described in the column of [Oxidized Cellulose], (N-oxyl Compound).

### (Content of Carboxy Group)

The content of a carboxy group in nanocellulose and the measuring method thereof according to the embodiment are the same as described in the column of [Oxidized Cellulose], (Content of Carboxy Group).

### (Average Fiber Length)

The average fiber length of the nanocellulose in the embodiment is preferably 50 to 700 nm, more preferably 50 to 500 nm, more preferably 50 to 300 nm, more preferably 60 to 300 nm, and still more preferably 70 to 200 nm.

If the average fiber length is 50 nm or more, a characteristic feature of the nanocellulose, i.e., viscosity, is easily developed. If the average fiber length is 700 nm or less, an excessive increase in viscosity of a slurry containing the nanocellulose is suppressed. As a result, the slurry tends to be easily handled.

### (Average Fiber Width)

The average fiber width of the nanocellulose according to the embodiment is preferably 1 to 200 nm, more preferably 1 to 15 nm, more preferably 1 to 10 nm, and still more preferably 1 to 5 nm.

If the average fiber width is 1 nm or more, the strength of the rubber containing the nanocellulose is easily improved. If the average fiber width is 200 nm or less, the nanocellulose is easily blended with a rubber component.

The average fiber width and average fiber length of the nanocellulose are values computationally obtained by mixing the nanocellulose and water such that a nanocellulose concentration is about 1 to 10 ppm, naturally drying the sufficiently-diluted aqueous cellulose dispersion on a mica substrate, observing the shape of the nanocellulose by a scanning probe microscope, randomly selecting an arbitrary number of fibers from the resulting image, and performing calculation by regarding the height of a shape image in the cross section as the fiber width and the value of the perimeter: 2 as the fiber length. In the calculation for such an average fiber width and an average fiber length, image processing software can be used. The conditions for image processing may be arbitrarily set. However, depending on the conditions, even if the same image is used, the calculated values may vary. The difference between values of the average fiber length varied depending on the conditions preferably falls within the range of ±100 nm. The difference between values with respect to the average fiber width depending on the conditions preferably falls within the range of ±10 nm.

The average fiber length and the average fiber width can be more specifically measured according to the following method.

The shape of the nanocellulose is observed by a scanning probe microscope “MFP-3D infinity” manufactured by Oxford Asylum in the AC mode.

The average fiber length is analyzed by binarization of the obtained image using image processing software “ImageJ”. The average fiber length is obtained with respect to 100 or more fibers in accordance with the following formula: fiber length=“peripheral length”=2.

The average fiber width is obtained as a number-average fiber width with respect to 50 or more fibers by using the software attached to the “MFP-3D Infinity” and regarding the height of a shape image in the cross section as the fiber width.

### (Aspect Ratio)

The aspect ratio (average fiber length/average fiber width) of the nanocellulose according to the embodiment is preferably 20 or more and 200 or less. If the aspect ratio is 200 or less, the dispersibility of the nanocellulose improves, and the strength of rubber tends to further improve. From the view point, the aspect ratio is more preferably 190 or less, and still more preferably 180 or less.

In contrast, if the aspect ratio is extremely low, in other words, if the nanocellulose has a thick rod-like shape rather than a long-thin fibrous shape, the nanocellulose is unevenly distributed and aggregated. As a result, dispersibility tends to decrease. Thus, the aspect ratio is preferably 20 or more, more preferably 30 or more, and still more preferably 40 or more.

The range of the aspect ratio of the nanocellulose can be determined based on the upper limits and lower limits appropriately in combination. The aspect ratio is preferably 20 or more and 200 or less, more preferably 30 or more and 190 or less, and still more preferably 40 or more and 180 or less.

### (Zeta Potential)

The zeta potential of the nanocellulose in the embodiment is preferably −30 mV or less. If the zeta potential is −30 mV or less (that is, the absolute value is 30 mV or more), microfibrils mutually act sufficiently repulsively, with the result that the nanocellulose having a high surface charge density is likely to generate during mechanical fibrillation. As a result, the dispersion stability of the nanocellulose is improved and a slurry having excellent stability in viscosity and handling can be obtained.

The lower limit of the zeta potential is not particularly limited, but is generally satisfactory if it is-100 mV or more. If the zeta potential is-100 mV or more (that is, the absolute value is 100 mV or less), oxidative scission in the fiber direction with the progress of oxidation tends to be suppressed. As a result, the nanocellulose uniform in size can be obtained; stability and dispersibility of the nanocellulose in water increases; and the nanocellulose is uniformly contained in the resulting dispersion.

From the above viewpoint, the zeta potential of the nanocellulose is preferably −35 mV or less, more preferably −40 mV or less, still more preferably −50 mV or less. The zeta potential of the nanocellulose is preferably −90 mV or more, more preferably −85 mV or more, more preferably −80 mV or more, more preferably −77 mV or more, more preferably −70 mV or more, and still more preferably −65 mV or more.

The range of the zeta potential of the nanocellulose can be determined based on the upper limits and lower limits appropriately in combination. The zeta potential is preferably −90 mV or more and −30 mV or less, more preferably −85 mV or more and −30 mV or less, more preferably −80 mV or more and −30 mV or less, more preferably −77 mV or more and −30 mV or less, more preferably −70 mV or more and −30 mV or less, more preferably −65 mV or more and −30 mV or less, and still more preferably −65 mV or more and −35 mV or less.

The zeta potential of the nanocellulose is a value measured at pH8.0, and 20° C., for an aqueous cellulose dispersion, prepared by mixing the nanocellulose and water so as to obtain a nanocellulose concentration of 0.1 mass %. Specifically, the zeta potential can be measured by the following method.

The dispersion containing the nanocellulose is diluted with pure water so as to obtain a concentration of the nanocellulose of 0.1%. A 0.05 mol/L aqueous sodium hydroxide solution is added to the diluted aqueous nanocellulose dispersion to adjust pH to 8.0, and the zeta potential is measured at 20° C. with a zeta electrometer (ELSZ-1000) manufactured by Otsuka Electronics Co., Ltd.

### (Light Transmittance)

The nanocellulose dispersion having the nanocellulose dispersed in a dispersion medium according to the embodiment has less light scattering or the like of cellulose fibers, and thus can exhibit high light transmittance. More specifically, the light transmittance of a mixed solution, which is prepared by mixing the nanocellulose and water so as to have a solid-content concentration of 0.1 mass %, is preferably 95% or more. The light transmittance is preferably 96% or more, further preferably 97% or more and still more preferably 99% or more. This light transmittance is the value measured at a wavelength of 660 nm by a spectrophotometer.

The light transmittance can be measured by the following method.

An aqueous dispersion of the nanocellulose having a solid content concentration of 0.1 mass % is placed in a quartz cell having a thickness of 10 mm, and the light transmittance at a wavelength of 660 nm is measured by a spectrophotometer (JASCO V-550).

The zeta potential and the light transmittance can be controlled by oxidation with hypochlorous acid or a salt thereof, and in particular, by controlling, e.g., time and temperature of the oxidation reaction and stirring conditions. More specifically, the reaction time is increased and/or the reaction temperature is increased. In accordance with this, oxidation towards the surface of cellulose microfibrils in a cellulose raw-material proceeds, and repulsion between the fibrils intensifies due to electrostatic repulsion and osmotic pressure, with the result that the average fiber-width tends to reduce. If one or more of time and temperature of the oxidation reaction, and stirring condition is set in a direction towards promoting oxidation (in other words, towards increasing the degree of oxidation), for example, if reaction time is set longer, the zeta potential tends to increase.

When a rubber composition is used as a masterbatch, the content of the nanocellulose is preferably 0.5 to 30 parts by mass, more preferably 1 to 25 parts by mass, and still more preferably 2 to 20 parts by mass based on 100 parts by weight of the rubber component (solid content).

When a rubber composition is directly used (in other words, a further rubber component is not added), the content of the nanocellulose is preferably 5 to 50 parts by mass, more preferably 8 to 40 parts by mass, and still more preferably 10 to 30 parts by mass, based on 100 parts by weight of the rubber component (solid content).

### [Method for Producing Nanocellulose]

The nanocellulose can be produced by fibrillating an oxidized cellulose as mentioned above. A production method is more specifically disclosed in WO 2022/009979 A and WO 2022/009980 A. The nanocellulose can also be obtained by fibrillating a commercially available oxidized cellulose (for example, ARONFIBRO (registered trademark) manufactured by Toagosei Co., Ltd.

### [Rubber Component]

The rubber composition according to the embodiment contains a rubber component in addition to the nanocellulose as mentioned above. Examples of the rubber component include natural rubber components and synthetic rubber components.

Examples of the natural rubber components include chemically unmodified natural rubber polymers; chemically modified natural rubber polymers such as a chlorinated natural rubber polymer, a chlorosulfonated natural rubber polymer, and an epoxidized natural rubber polymer; hydrogenated natural rubber polymers; and deproteinized natural rubber polymers.

Examples of the synthetic rubber components include diene-based rubber polymers such as a butadiene rubber (BR) polymer, a styrene-butadiene copolymer rubber (SBR) polymer, an isoprene rubber (IR) polymer, an acrylonitrile-butadiene rubber (NBR) polymer, a chloroprene rubber (CR) polymer, a styrene-isoprene copolymer rubber polymer, a styrene-isoprene-butadiene copolymer rubber polymer, and an isoprene-butadiene copolymer rubber polymer; and a non-diene rubber polymers such as a butyl rubber (IIR) polymer, an ethylene-propylene rubber (EPM, EPDM) polymer, an acrylic rubber (ACM) polymer, an epichlorohydrin rubber (CO, ECO) polymer, a fluoro rubber (FKM) polymer, a silicone rubber (Q) polymer, a urethane (U) rubber polymer, and a chlorosulfonated polyethylene (CSM) polymer.

The state of the rubber component may be solid, a dispersion (latex) having the rubber component dispersed in a dispersion medium, or a solution having a rubber component dissolved in a solvent. Examples of the dispersion medium and the solvent include water and organic solvents. The amount of each of the dispersion medium and the solvent may be 10 to 1000 parts by mass with respect to 100 parts by weight of the rubber component.

The rubber component may be not yet crosslinked or partly crosslinked.

### [Other Components]

The rubber composition according to the embodiment may contain other components. Examples of the other components include a crosslinking agent described in the column of <Rubber> described later.

### <Method for Producing Rubber Composition>

The rubber composition according to the embodiment can be produced by appropriately mixing the nanocellulose according to the embodiment and a rubber component. The rubber composition according to the embodiment may be produced by mixing the nanocellulose according to the embodiment and a rubber component by a commonly known method. The method for producing a rubber composition containing the nanocellulose is not particularly limited. The rubber composition can be produced, for example, by a method using an open roll, more specifically, with reference to JP 2015-98576 A.

An embodiment of the invention relates to a method for producing a rubber composition according to the embodiment including a step of mixing the nanocellulose according to the embodiment and a rubber component to obtain a mixture, and a dispersion step of thinning the mixture by passing it through an open roll to obtain a rubber composition. In the dispersing step, the nanocellulose can be dispersed in the rubber composition.

The rubber composition according to the embodiment can also be produced by melt-kneading a mixture of the nanocellulose according to the embodiment and a rubber component. As a result, the breaking-elongation ratio according to the embodiment can be controlled to be higher. More specifically, the rubber composition according to the embodiment can also be produced by a production method including a step of mixing the nanocellulose according to the embodiment and a rubber component to obtain a first mixture, a step of drying the first mixture, and a step of melt-kneading the dried first mixture. The first mixture is preferably subjected to a process of dispersing the nanocellulose by a stirrer such as a homomixer or a planetary stirrer in order to increase a breaking-elongation ratio.

### <Rubber>

An embodiment of the invention relates to a rubber formed from the rubber composition described above. The rubber according to the embodiment can also be expressed as a cross-linked product of the rubber composition.

An embodiment of the invention relates to a rubber formed from a rubber composition, in which the rubber composition contains the nanocellulose and a rubber component; the nanocellulose contains a cellulose raw-material oxidized with hypochlorous acid or a salt thereof and substantially contains no N-oxyl compound; and the ratio of the breaking-elongation value of the rubber relative to the breaking-elongation value of a control rubber formed from a control rubber composition, which is prepared by removing the nanocellulose from the rubber composition, is 0.90 or more and less than 1.15. The details of the rubber composition, the control rubber composition, and the breaking-elongation ratio herein are the same as described in the column of <Rubber composition> above.

The rubber according to the embodiment is obtained, for example, by heating a rubber composition and/or reacting the rubber composition with a crosslinking agent. Examples of the crosslinking agent include sulfur, metal oxides, resin crosslinking agents, organic peroxides, and triazine derivatives. These can be used singly or in combination of two or more types.

Examples of sulfur include powder sulfur, fine-powder sulfur, precipitated sulfur, colloidal sulfur, and sulfur chloride.

Examples of the metal oxides include magnesium oxide, calcium oxide, zinc oxide, and copper oxide.

Examples of the resin crosslinking agents include alkylphenol formaldehyde resins such as an alkylphenol formaldehyde resin, a thermally reactive phenol resin, a phenol dialcohol-based resin, a bisphenol resin, and a thermally reactive bromomethylalkylated phenol resin.

Examples of the organic peroxides include alkyl peroxides, aryl peroxides, acyl peroxides, ketone peroxides, peroxyketals, peroxycarbonates, peroxyesters, and hydroperoxides. As the organic peroxide, for example, dicumyl peroxide can be suitably used.

Examples of the triazine derivatives include 2,4,6-trimercapto-s-triazine, 2-methylamino-4,6-dimercapto-s-triazine, 2-(n-butylamino)-4,6-dimercapto-s-triazine, 2-octylamino-4,6-dimercapto-s-triazine, 2-propylamino-4,6-dimercapto-s-triazine, 2-diallylamino-4,6-dimercapto-s-triazine, 2-dimethylamino-4,6-dimercapto-s-triazine, 2-dibutylamino-4,6-dimercapto-s-triazine, 2-di(iso-butylamino)-4,6-dimercapto-s-triazine, and 2-dipropylamino-4,6-dimercapto-s-triazine, 2-di(2-ethylhexyl)amino-4,6-dimercapto-s-triazine, 2-dioleylamino-4,6-dimercapto-s-triazine, 2-laurylamino-4,6-dimercapto-s-triazine or 2-anilino-4,6-dimercapto-s-triazine, or a sodium salt or a disodium salt thereof.

The addition amount of the crosslinking agent may be appropriately controlled, and is usually 0.01 to 15 parts by mass, preferably 0.1 to 10 parts by mass, and more preferably 0.1 to 5 parts by mass based on 100 parts by mass of the rubber component.

The temperature during crosslinking may be appropriately controlled, and may fall within the range of 20 to 200° C.

### EXAMPLES

Hereinafter, the invention will be described in more detail with reference to Examples and Comparative Examples, but the technical scope of the invention is not limited thereto. Note that “parts” and “%” in the following description mean parts by mass and mass %, respectively, unless otherwise specified. Hereinafter, phr (parts per hundred rubber) means parts by weight of the substance based on 100 parts by weight of the rubber component.

### <Measurement of Carboxy-Group Content>

To 60 ml of aqueous oxidized cellulose dispersion controlled so as to have an oxidized cellulose concentration of 0.5 mass %, a 0.1 M aqueous hydrochloric acid solution was added to set pH at 2.5. Thereafter, a 0.05 N aqueous sodium hydroxide solution was added dropwise and the electrical conductivity was measured until the pH reached 11.0. The amount (a) of sodium hydroxide, which was consumed in a stage of neutralizing weak acid where the electrical conductivity slightly changed, was obtained and substituted into the following formula. In this manner, the content of a carboxy group (mmol/g) was computationally obtained.

Content of carboxy-group=a (ml)×0.05/mass (g) of the oxidized cellulose

### Production Example 1: Production of Oxidized Cellulose

Pulp (KC FLOCK W100GK, Nippon Paper Industries Co., Ltd.) was used as a cellulose raw-material.

In a beaker, 350 g of sodium hypochlorite pentahydrate crystal having an available chlorine concentration of 42 mass % was placed and pure water was added. The mixture was stirred to obtain an aqueous sodium hypochlorite solution having an available chlorine concentration of 21 mass %. To the mixture, 35 mass % hydrochloric acid was added. The mixture was stirred to adjust the pH to 11.0. The aqueous sodium hypochlorite solution was stirred at 200 rpm using a propeller-form stirring blade of a stirrer (three-One Motor, BL600) manufactured by Shinto Scientific Co., Ltd., and simultaneously placed in a constant-temperature water bath to control the temperature to be 30° C., and thereafter, 50 g of the pulp was added.

After adding the cellulose raw-material, the temperature was kept at 30° C. in the same constant-temperature water bath. While keeping this state, the pH during the reaction was maintained at 11.0 by adding a 48 mass % aqueous sodium hydroxide solution. Stirring was performed at 200 rpm by a propeller-form stirring blade, and an oxidation reaction was performed for 4 hours (pH was continuously maintained).

After completion of the reaction, solid-liquid separation of the product was made by pressure filtration using a filter cloth (KE022 manufactured by Nakao Filter Co., Ltd., air permeability 0.3 cc/cm²/sec). The obtained oxidized cellulose solid was washed with pure water. The content of the carboxy group in the oxidized cellulose was 0.7 mmol/g.

The available chlorine concentration in the aqueous sodium hypochlorite solution was measured by the following method.

### (Measurement of Available Chlorine Concentration in Aqueous Sodium Hypochlorite Solution)

An aqueous solution (0.582 g) containing a sodium hypochlorite pentahydrate crystal in pure water was precisely weighed. To this, 50 mL of pure water was added and 2 g of potassium iodide and 10 mL of acetic acid were added. Immediately after, the container was tight sealed and allowed to stand for 15 minutes in a dark place. After 15 minutes of standing, the liberated iodine was titrated with a 0.1 mol/L sodium thiosulfate solution (solution factor: 1.000). As a result (indicator: starch reagent solution), the titer was 34.55 mL. Separately, a blank test was performed and correction was made. Since 1 mL of the 0.1 mol/L sodium thiosulfate solution corresponds to 3.545 mg of Cl, the available chlorine concentration in the aqueous sodium hypochlorite solution was 21 mass %.

### Production Example 2: Production of Nanocellulose

The aqueous oxidized cellulose dispersion (solid content: 7.5%) obtained in Production Example 1 was processed by a homomixer (ROBOMIX manufactured by PRIMIX Corporation) at 10,000 rpm in a liquid volume of 300 mL for 46 minutes to fibrillate the oxidized cellulose into a nanocellulose. In this manner, an aqueous nanocellulose dispersion was obtained. The average fiber width was 3.7 nm, and the average fiber length was 150 nm.

### Example 1

Nitrile butadiene rubber latex (Nipol LX513 manufactured by Zeon Corporation, concentration: 45 wt %, hereinafter, the rubber was referred to as “NBR”) having a solid content of 100 phr and the aqueous nanocellulose dispersion (solid content: 7.5 wt %) having a solid content of 20 phr obtained in Production Example 2 were mixed. The mixture was processed by a homomixer (ROBOMIX manufactured by PRIMIX Corporation) at 3,000 rpm for 1 minute, mixed by a planetary stirrer (Awatori Rentaro ARE310 manufactured by Thinky Corporation) at 2,000 rpm for 30 seconds, and defoamed and dispersed at 2,200 rpm for 30 seconds to obtain a rubber composition.

To the rubber composition, NBR rubber alone (dried product by the method of Comparative Example 1 described later) was added in an amount enough to dilute CNF to 5 phr. The mixture was casted in a plastic vat, and dried at 50° C. for 3 days. This casted and dried product was pre-kneaded with a batch-form melt-kneader (Labo Plast Mill 10 S100 manufactured by Toyo Seiki Seisaku-sho, Ltd., mixer R60, Banbury blade) at a set temperature of 40° C. and a rotation number of 60 rpm for 5 minutes, and 3.2 phr of a crosslinking agent (PERCUMYL D manufactured by NOF CORPORATION (also referred to as “DCP”)) was added. The mixture was further kneaded for 10 minutes to obtain a kneaded product.

The kneaded product was placed in a mold having a thickness of 1 mm. The upper and lower portions of the mold were sandwiched by SUS plates. Processing was performed by a hot press machine at 165° C., 20 MPa, for 30 minutes to perform a crosslinking reaction and molding. In this manner, a sheet-like rubber containing 5 phr of CNF was obtained. The strength test of the obtained sheet-like rubber was performed in accordance with <Strength Evaluation> described later.

### Comparative Example 1

A rubber alone was kneaded and evaluated. More specifically, NBR latex was casted in a plastic vat and dried at 50° C. for 3 days. Hereinafter, the kneading and test were performed in the same manner as in Example 1.

### Example 2

Carboxy-modified NBR latex (Nipol1571C2 manufactured by Zeon Corporation, solid content: 45 mass %, hereinafter, the rubber is referred to as “X-NBR”) and the aqueous oxidized cellulose dispersion obtained in Production Example 2 were kneaded by a rotation-revolution stirrer (rotation and revolution mixer manufactured by Thinky Corporation) to obtain a mixed solution. Subsequently, the mixed solution was poured in a vat and dried in an oven at 40 to 50° C. for about 24 hours to remove the aqueous solvent. In this manner, a mixture was obtained. The water content of the obtained mixture was 5% or less.

Subsequently, the mixture was wound around an open roll (twin-roll, 191 TH test mixing roll manufactured by YASUDA SEIKI SEISAKUSHO, LTD.) and kneaded, and then thinned through the roll (roll temperature 10° C. to 30° C., distance between rolls: 0.3 mm or less, roll speed ratio 1.1) to obtain an intermediate.

Furthermore, the intermediate was again wound around the open roll. After zinc oxide and an anti-aging agent were mixed, further a crosslinking agent (DCP) was added thereto and mixed. The sheets separately fed out were subjected to pressure forming at 165° C. for 30 minutes to obtain sheet-like crosslinked rubber samples having a thickness of 1 mm.

### Comparative Example 2

A rubber alone was kneaded and evaluated. More specifically, X-NBR latex was casted in a plastic vat and dried at 50° C. for 3 days. Hereinafter, kneading and testing were performed in the same manner as in Example 2.

### <Strength Evaluation>

The strength evaluation was performed by the following tensile test.

No. 6 dumbbell-form samples (thickness: 1.1 to 1.2 mm) specified in JIS K6251 were cut out from the sheet-like rubber and subjected to a tensile test by a tensile tester (INSTRON 5566 A, manufactured by INSTRON) at 23±2° C., a gauge length of 20 mm, and a tension rate of 500 mm/min in accordance with JIS K6251.

In the tensile test, items: 50% modulus (050 (MPa)), 100% modulus (σ100 (MPa)), 300% modulus (σ300 (MPa)), tensile strength (TS (MPa)), breaking elongation (Eb (%)), and elastic modulus, were measured.

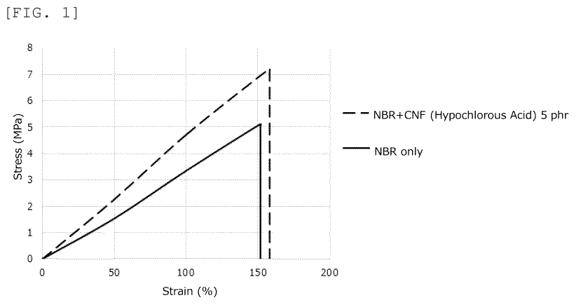

The strength evaluation results of the rubbers are shown in Table 1. The results of Example 1 and Comparative Example 1 are shown in FIG. 1. The breaking-elongation ratio of Example 1 was obtained based on Comparative Example 1. The breaking-elongation ratio of Example 2 was obtained based on Comparative Example 2.

TABLE 1

| | | | | Comparative | | Comparative |
|---|---|---|---|---|---|---|
| | | | Example 1 | Example 1 | Example 2 | Example 2 |
| Formulation | NBR | Parts by mass | 100 | 100 | 0 | 0 |
| | X-NBR | Parts by mass | 0 | 0 | 100 | 100 |
| | (Hypochlorous acid) CNF | Parts by mass | 5 | 0 | 20 | 0 |
| | DCP | Parts by mass | 3.2 | 3.2 | 3.2 | 3.2 |
| Physical | Modulus σ50 | MPa | 2.3 | 1.5 | 3.7 | 1.7 |
| properties | Modulus σ100 | MPa | 4.7 | 3.3 | 3.7 | 2.5 |
| | Modulus σ300 | MPa | — | — | — | — |
| | Tensile strength TS | MPa | 7.2 | 5.1 | 23.5 | 10.0 |
| | Breaking elongation Eb | % | 158 | 152 | 260 | 230 |
| | Elastic modulus | MPa | 4.8 | 3.8 | — | — |
| | Breaking-elongation ratio | — | 1.04 | — | 1.13 | — |

The CNF content is not the amount of CNF dispersed liquid but the amount of CNF itself.

1. A rubber composition comprising a nanocellulose and a rubber component,
wherein the nanocellulose contains a cellulose raw-material oxidized with a hypochlorous acid or a salt thereof and substantially contains no N-oxyl compound, and
the ratio of a breaking-elongation value of a rubber formed from the rubber composition relative to a breaking-elongation value of a control rubber formed from a control rubber composition, which is prepared by removing the nanocellulose from the rubber composition, is 0.90 or more and less than 1.15.

2. The rubber composition according to claim 1,
wherein a content of the nanocellulose is 0.5 parts by mass or more and 50 parts by mass or less based on 100 parts by mass of the rubber component.

3. The rubber composition according to claim 1, wherein the rubber composition is used as a masterbatch.

4. A rubber formed from the rubber composition according to claim 1.

5. A rubber formed from a rubber composition,
wherein the rubber composition contains a nanocellulose and a rubber component,
the nanocellulose contains a cellulose raw-material oxidized with a hypochlorous acid or a salt thereof and substantially contains no N-oxyl compound, and
a ratio of a breaking-elongation value of the rubber relative to a breaking-elongation value of a control rubber formed from a control rubber composition, which is prepared by removing the nanocellulose from the rubber composition, is 0.90 or more and less than 1.15.
